(19) United States
(12) Patent Application Publication
(10) Pub. No.: US 2006/0108141 A1
(43) Pub. Date: May 25, 2006

(54) Portable electronic information and/or entertainment rendering devices carrier

(76) Inventors: Wayne M. Torcivia, Ronkonkoma, NY (US); Leonardo A. Santana, Ronkonkoma, NY (US)

Correspondence Address: Wayne M. Torcivia, 60 Creighton Avenue, Ronkonkoma, NY, 11779, US

(21) Appl. No.: 10/994,807

(22) Filed: Nov. 22, 2004

(51) Int. Cl. H01B 7/00

(52) U.S. Cl. 174/135

(57) ABSTRACT

The nature of the device herein described is as follows: It is a carrier for portable electronic information and/or entertainment rendering devices. The carrier engages the contour(s) and/or edge(s) of the aforementioned devices and by means of frictional surface forces prevents slippage. It is an attacheable and detacheable carrier. The carrier attaches to the portable information and/or entertainment rendering devices by means of hooks and frictional force. The carrier attaches to the user by means of a spring-loaded hook.

### BACKGROUND OF THE INVENTION

Portable compact disc players and/or other media playing devices, pocket computers, dedicated game consoles and wearable computers are very convenient and useful electronic devices to have for the convenience of enjoying a diverse universe of entertainment and information wherever and whenever the user wants to do so; However, We have found that the great majority of O.E.M. have neglected to include with the aforementioned devices, a convenient and safe way to carry them.

The method we have devised allows the user to carry the portable electronic information and/or entertainment rendering devices in a safe, convenient and reliable way. This method is safe for both the user and the device. The user does not have to become entangled with any hanging straps ropes, strings, wires or too many hooks, . . . , etc. The portable information and/or entertainment rendering device is kept safe from falling to the ground and being damaged or totally destroyed. We have tested this carrier in several environments to make sure that the assertions we make herein, are true.

The convenience of the carrier refers to its seamlessness, ease and intuitive utilization. The user will attach the carrier to the portable electronic information and/or entertainment rendering device and then clip it to himself/herself around the waistband, shirt pocket, pants pockets, blouse or shirt collar, back of the blouse or shirt collar, . . . , wherever there is a contour to hook up with.

The reliability of the carrier comes from the geometrical structure of it and the type of materials we used to manufacture it. The materials we used allow for maximum flexibility, elasticity and strength. The carrier can be attached and detached, respectively, on and off the portable electronic information and/or entertainment rendering devices.

We have already created a working prototype; it can be attached and detached at will to and from several models of portable compact disc players we have tested, from a particular manufacturer. We have tested its reliability by going to gymnasiums, running in tracks, going shopping, . . . , etc. So far, we have not had an accidental detachment event, yet.

### BRIEF SUMMARY OF THE INVENTION

In summary, the device is an attacheable and detacheable carrier for portable electronic information and/or entertainment rendering devices without a built-in attachment clip (see definitions below).

Which device the carrier will mate with is determined at the time of manufacture; depending on the particular device, model and manufacturer, a small modification on the upper and lower portions of the carrier and decreasing/increasing its longitudinal length will make it engage the particular portable electronic information and/or entertainment rendering device.

We consider the following electronic devices and any combination thereof, to be portable electronic information and/or entertainment rendering devices:

Definitions:

1. portable compact disc players with/without (digital/analog) radio receiver.
2. portable electronic media rendering devices (digital video/digital audio regardless of format).
3. portable digital video disc players with/without wearable display and/or with/without terrestrial/satellite (digital/analog) television receiver.
4. portable (digital/analog) terrestrial/satellite television receiver with/without wearable display.
5. portable (digital/analog) satellite radio receiver.
6. portable (digital/analog) terrestrial radio receiver.
7. portable (digital/analog) terrestrial radio transceiver.
8. portable dedicated electronic game consoles.
9. pocket computers.
10. wearable computers.
   Drawing Point of View Descriptive Statement

### THE VIEWS: (BRIEF DESCRIPTION)

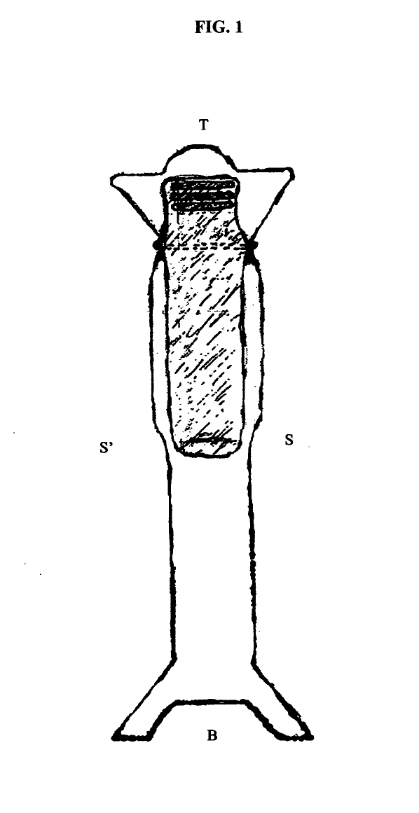

a. FIG. 1: REAR

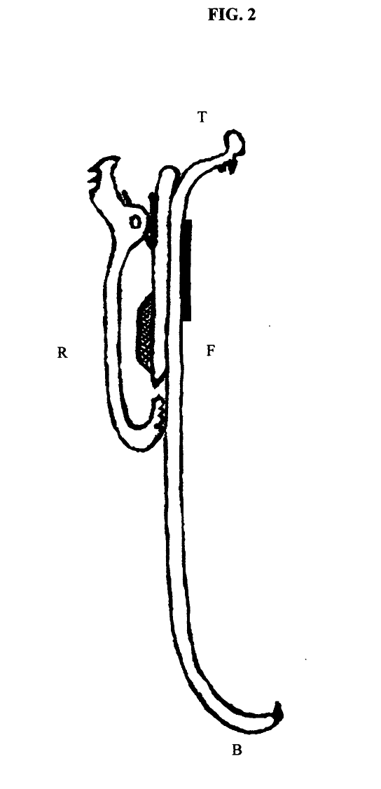

b. FIG. 2: LATERAL (RIGHT and LEFT, SYMMETRICAL)

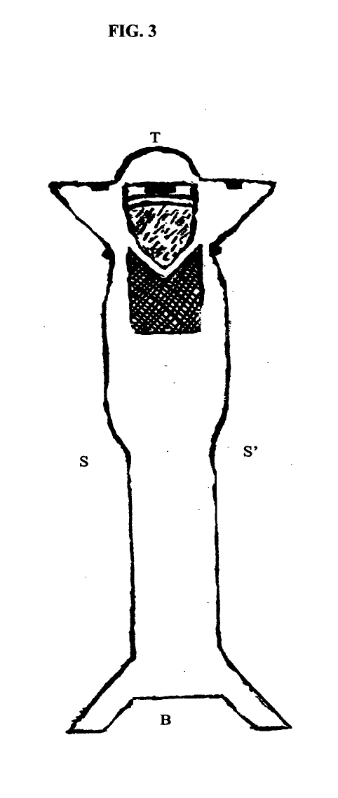

c. FIG. 3: FRONT

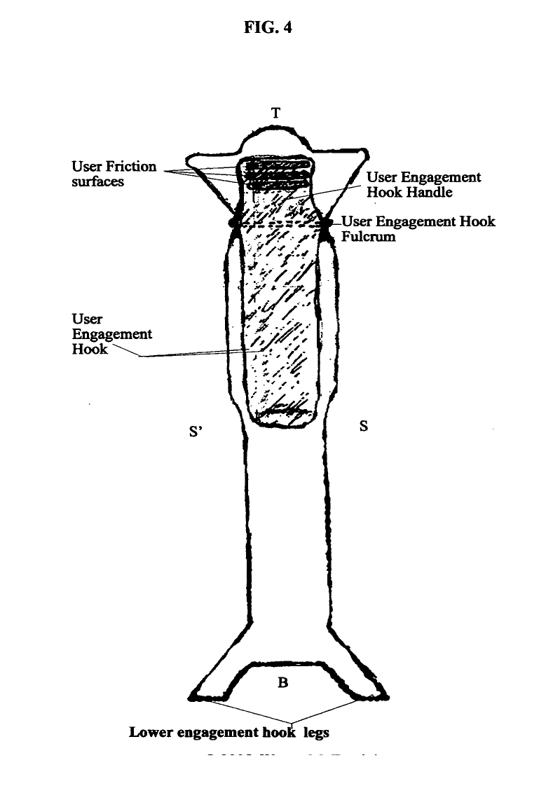

d. FIG. 4: REAR (with parts named)

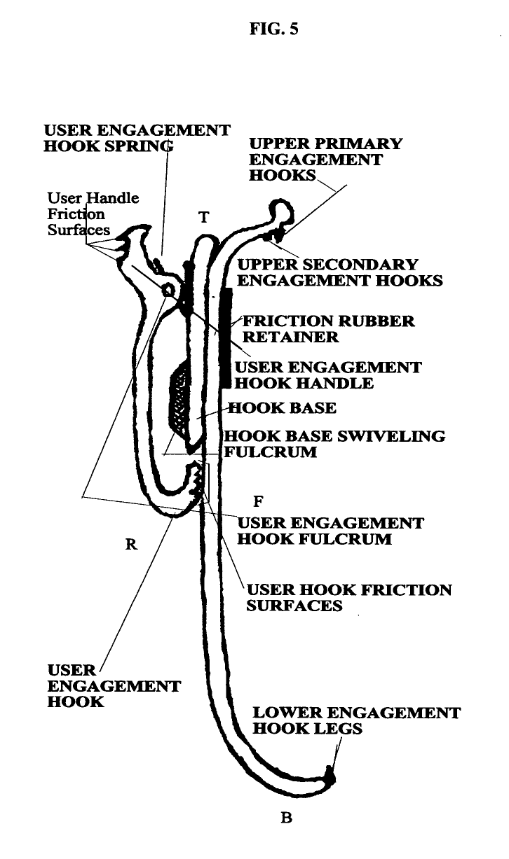

e. FIG. 5: LATERAL (RIGHT and LEFT, SYMMETRICAL with parts named)

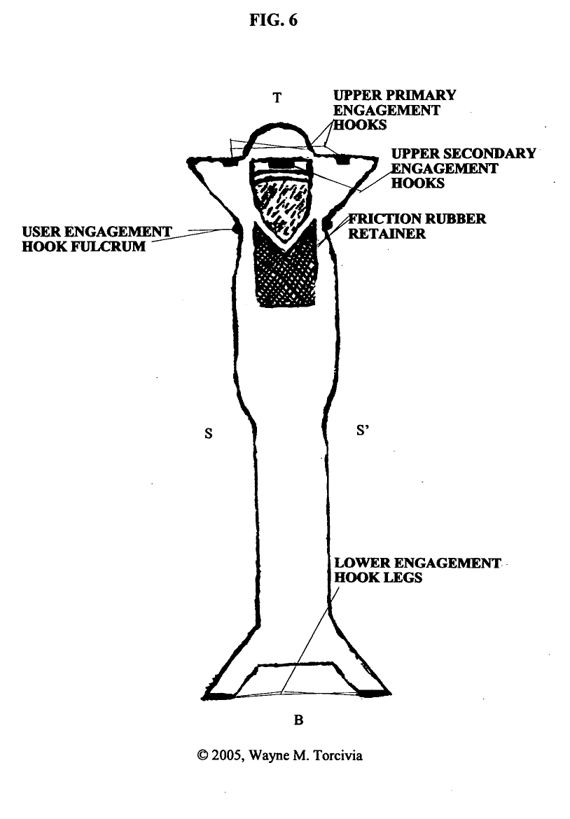

f. FIG. 6: FRONT (with parts named)

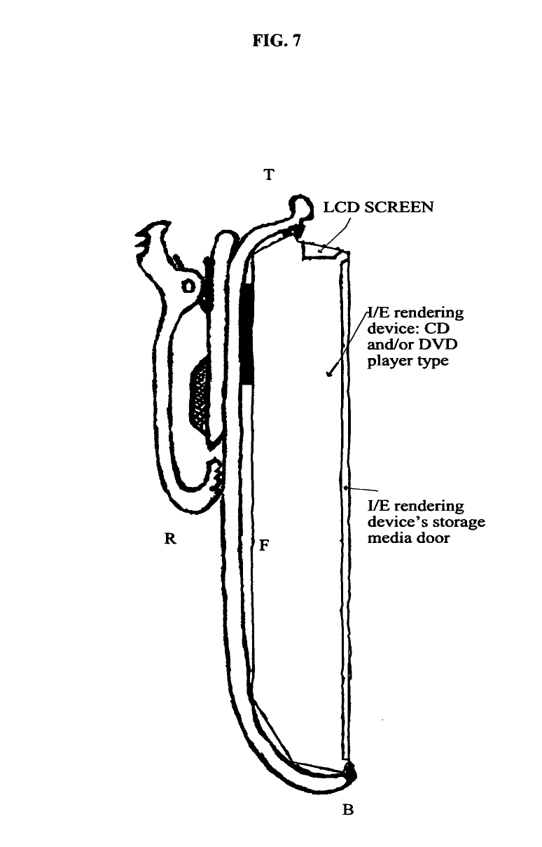

g. FIG. 7: ENGAGEMENT (LATERAL PERSPECTIVE)

### DESCRIPTIVE GEOMETRY: (BRIEF DESCRIPTION)

Axes definitions and reference points are as follows:

1. The TOP-BOTTOM axis is denoted and spanned by the upper case symbol T (reference point for TOP) and upper case letter B (reference point for BOTTOM).
2. The FRONT-REAR axis is denoted and spanned by the upper case symbol F (reference point for FRONT) and upper case symbol R (reference point for REAR).
3. The SIDE-SIDE axis is denoted and spanned by the upper case symbol S (reference point for SIDE 1) and upper case symbol S′ (reference point for SIDE 2).

In FIG. 1 and FIG. 4, the carrier prototype for compact disc players is shown from a rear perspective. The most important parts are shown, respectively. The upper case letter T indicates the top of the carrier and the lower case letter B indicates the bottom of the carrier.

In FIG. 2 and FIG. 5, the compact disc player carrier prototype is shown from a lateral approach. The carrier is symmetrical alongside its TOP-BOTTOM axis, hence only one of the two possible lateral views is shown.

In FIG. 3 and FIG. 6, the carrier prototype for portable compact disc players is shown from a frontal approach. The carrier prototype for portable compact disc players has no symmetry alongside its FRONT-REAR or SIDE-SIDE axis.

In FIG. 7, the carrier prototype for portable compact disc players is shown engaging an actual portable compact disc player. It can be noted, that the carrier engages the compact disc player in an unobstrussive manner and allows the physical media to be placed into and removed from the portable compact disc player (an information and/or entertainment rendering device).

### DETAILED DESCRIPTION OF THE INVENTION

As it applies to all information contained herein, we are defining as portable electronic information and/or entertainment rendering devices the following:
1. portable compact disc players with or without terrestrial/satellite (digital/analog) radio receiver.
2. portable electronic media rendering devices (digital video/digital audio regardless of format).
3. portable digital video disc players with/without wearable display and/or with/without terrestrial/satellite (digital/analog) television receiver.
4. portable (digital/analog) terrestrial/satellite television receiver with/without wearable display.
5. portable (digital/analog) satellite radio receiver.
6. portable (digital/analog) terrestrial radio receiver.
7. portable (digital/analog) terrestrial radio transceiver.
8. portable dedicated electronic game consoles.
9. pocket computers
10. wearable computers

The carrier device is designed to be attached or detached at will and with ease on/off the portable electronic information and/or entertainment rendering devices; This in turn allows the user to carry and use the aforementioned devices attached to his/her belt, pant pockets, shirt pockets, T-shirt neck, pant or skirt waistline, purse pocket, carrying case pocket, etc. With very small modifications at the upper and lower portions of the carrier and its longitudinal length, it can be mated to many different types of portable electronic information and/or entertainment rendering devices. The initial prototype, was meant to mate with a specific compact disc player model from one particular manufacturer; soon we realized that we could use the carrier with other compact disc players from that same manufacturer. In addition, we realized that by making slight changes on the upper and lower engaging points of the carrier, we can mate the carrier to other compact disc players and other media playing devices from the same and other manufacturers. Furthermore, we realized that the carrier could be modified easily to mate to portable electronic dedicated game consoles, pocket computers and wearable computers.

In this manner, the user of the portable electronic information and/or entertainment rendering device, can enjoy the use of the device without the hassle of hanging strings and/or straps. Furthermore, the worry of accidental damage to the portable electronic information and/or entertainment rendering device due to an accidental fall is greatly minimized regardless of the activity in which the user is involved. The carrier device is very unobstrussive. Furthermore, we have personally tested the carrier device on a physical fitness center setting. We have done the following while wearing the carrier device on our fitness pants carrying number #1 (see “Tested Compact Disc Players and Other Media Playing Devices”).

What is new and different with this portable electronic information and/or entertainment rendering device carrier is that it allows the user to change the media without unbuffoning or unstrapping anything. Furthermore, the user is able to carry the portable electronic information and/or entertainment rendering device anywhere on his/her body where there is a closed loop-like topology. Furthermore, is light weight, compact and unobstrussive. and/or entertainment rendering devices is not by engolfing them in a protective “pouch”, but by engaging the built-in edges, crevices and contours (when available) on the portable electronic information and/or entertainment rendering devices. The “carrier” uses small hooks and frictional surface forces to attach itself to the portable electronic information and/or entertainment rendering devices, thus preventing accidental detachment and slippage.

Mode of Engagement:
portable electronic information and/or entertainment rendering device type:
   Portable Compact Disc Players

Pick up the carrier by its back on one hand and then pick up the compact disc player and/or other media playing device with the other hand. Bring the back of the compact disc player and/or other media playing device in front of the carrier. Now, engage the bottom hooks of the carrier with the lower edge(s) and/or contour(s) of the compact disc player and/or other media playing device. When this engagement has been achieved, Now, proceed to engage the top of the compact disc player and/or other media playing device with the top of the carrier; now, proceed to push the compact disc player and/or other media device upper edges and/or contour(s) towards the upper double row of hooks; when the double “clicking” sound is heard, full engagement has been achieved. These procedures were tested with the working prototype as it applies to the compact disc players and/other media playing devices as described in:

“Tested Compact Disc Players and Other Media Playing Devices”.

Tested Activities and Environments:

Indoors:

Thread Mill, Weight Lifting, Frontal Crunches, Lateral Crunches, Circuit Running, Office work, Warehouse work, Auto repair shop, Light manufacturing, Sitting, Walking.
   Outdoors:
Jogging, Running, Bicycling, Fishing(*), Walking, Hiking, Skiing, Roller-Blading, Skating, Motorbicycle racing (Track/Field), Mountain climbing, Surfing(*), Boating(*), Water Skiing(*), Skateboarding.
(*) The compact disc player and/or other media devices must be protected against water damage.
   Tested Compact Disc Players and Other Media Playing Devices:
   1. SONY(®) “Car Ready Walkman” with G-Protection

[Model Name: CD WALKMAN Model Number: D-EJ368CK]

Manufacturer Address:

Sony Corporation

6-7-35 Kitashinagawa; Shinagawa-ku, Tokyo, 141-0001 Japan ZHT

[Manufacturer locale: SONY Corp., China]

[Serial Number: 3-250-565-01]

2. SONY(®) “Sportsman Walkman” with G-Protection

[Model Name: CD WALKMAN Model Number: unknown]

Manufacturer Address:

Sony Corporation

6-7-35 Kitashinagawa; Shinagawa-ku, Tokyo, 141-0001 Japan ZHT

[Manufacturer locale: SONY Corp., China]

[Serial Number: unknown]

3. SONY(®) “Digital Tuner/CD Player Walkman” with G-Protection

[Model Name: RADIO/CD WALKMAN Model Number: D-FJ210]

Manufacturer Address:

Sony Corporation

6-7-35 Kitashinagawa; Shinagawa-ku, Tokyo, 141-0001 Japan ZHT

[Manufacturer locale: SONY Corp., China]

[Serial Number: unknown]

4. Durabrand(®) CD 855 Programmable CD player with ESP and Remote Control

[Model Name: Durabrand CD 855 Model Number: CD 855]

Manufacturer Address:

Lennox Electronics, Corp.

2 Germak Drive, Carteret, N. J. 07008

[Manufacturer locale: Lenoxx Electronics, Corp., China]

[Serial Number: unknown]

Tools and Materials Utilized:
1. ABS Plastic
2. One cellular telephone belt-carrying clip.
3. One piece of neoprene rubber
4. (Chemical Compound): SEM(®) 39768 part B “Problem Plastic Repair Material”
5. (Chemical Compound): Crazy Glue(™).
6. One Plastic Cutting Blade.
7. One 0.7 KW heat gun with adjustable thermal control.
8. Miniature tweezers.

Method of Manufacture:
note: The original working prototype was meant to engage one particular compact disc player model from one particular manufacturer.
   1. We cut the cellular telephone's belt-carrying clip with a standard plastic cutting blade.
   2. We proceeded to measure and cut the piece of ABS plastic to the proper dimensions we wanted with a standard plastic cutting blade.
   3. We cut the ABS plastic to the following dimensions:
      Length: 3 inches
      Width: ½ inches
      Thickness: 1/16 inches
   4. We then proceeded to remove the excess amount of ABS plastic no longer needed for the particular shape we had in mind.
   5. Using a heat gun and miniature tweezers, we proceeded to shape the bottom half of the previously cut cellular telephone's belt-carrying clip. In this manner, we made it accommodate and engage in a secure manner, the bottom of the compact disc player. Using the heat gun, we molded the lower portion of the compact disc players carrier to be accepted by the groove provided by the manufacturer of the compact disc player.
   6. When we were assured this section of the device was finished to our satisfaction, we then proceeded to measure and cut the 3-inch piece of ABS plastic to the proper length needed in order to have the upper portion of the cellular telephone's belt carrying clip be accepted by the existing lip provided by the compact disc player.
   7. We then proceeded to mix the two part epoxy to secure the piece of ABS plastic cut to the proper dimensions to extend the upper portion of the clip and attach it to the lower portion of the clip to accept the proper device at hand, which happened to be a compact disc player.
   8. We then used a piece of rubber 1 inch-square by one-sixteenth inch thick for the prevention of any potential slippage or sliding of the compact disc player when engaged to the portable electronic information and/or entertainment rendering device carrier.
   9. We then cut to the proper size the upper portion of the cellular telephone's belt-carrying clip. Using Crazy Glue(™), we glued the 1 inch-square by one-sixteenth inch thick rubber piece to this upper portion where the center base of the clip meets the compact disc player's back.
   10. In turn, the upper portion of the clip did not need any modification at hand.
   11. In this manner, the portable electronic information and/or entertainment rendering device carrier is finished and ready to be used for the portable compact disc player.

What we claim as our invention is as follows:

1. An attach-and-forget, attachable and detachable carrier device for portable compact disc players and other portable electronic information and/or entertainment rendering devices without a built-in carrying clip wherein the carrier device can rotate 360 degrees clockwise and counterclockwise, locking at 90 degrees intervals or any other angular interval desired modifiable at the time of manufacturing: the rotation takes place on the Diane perpendicular to the normal on the user body and can be used on any apparel with quasi-closed or closed-loop curve topology features worn by the user by attaching or detaching the carrier device as a vise on or from the aforementioned topologies respectively.

2. A carrier for portable compact disc players and other portable electronic information and/or entertainment rendering devices that utilizes frictional surface force and engages the edges and contours of the aforementioned devices to lock them in place without the use of buttons and/or straps to hold the portable electronic information and/or entertainment rendering device in place.

3. A carrier that does not wholly contain or engulf, but mates with the portable compact disc players or any other portable electronic Information and/or entertainment rendering devices given some modifications to the parameters of length, width, thickness and radial curvature on the body of the carrier.

4. A device carrier that allows the unhindered operation of the controls on and exchange of physical storage media to and from the portable compact disc player or any other portable electronic information and/or entertainment rendering device, respectively, whether or not the user is wearing the portable electronic information and/or entertainment rendering device.

5. An adaptable and dimensionally adjustable carrier able to mate with the wide variety of portable electronic information and/or entertainment rendering devices, wherein the adjustments can be done at the time of manufacturing to fit the topology of the particular compact disc player or any other portable electronic information and/or entertainment rendering device.
